(19) United States
(12) Patent Application Publication
(10) Pub. No.: US 2012/0087467 A1
(43) Pub. Date: Apr. 12, 2012

(54) X-RAY BASED DENSITOMETER FOR MULTIPHASE FLOW MEASUREMENT

(75) Inventor: Stein-Arild TJUGUM, Laksevag (NO)

(73) Assignee: ROXAR FLOW MEASUREMENT AS, Bergen (NO)

(21) Appl. No.: 12/902,473

(22) Filed: Oct. 12, 2010

(51) Int. Cl. G01N 23/12

(52) U.S. Cl. 378/54

(57) ABSTRACT

Multiphase flow measuring unit for performing X-ray density measurements on a fluid flow, the unit comprising an X-ray source generating an X-ray beam within a chosen spectral range and a first detector aimed at the beam for detecting radiation scattered by or transmitted through the flow, the spectral range being a narrow, essentially monochromatic range.

### INTRODUCTION

Flow measurements by use of gamma-ray attenuation has been utilised in multiphase flow meters for many years. This represents a robust and reliable type of flow composition measurement [1]. The use of a radioactive isotope does however introduce some challenges. When using radioactive sources there is additional paper work to be done, the source has to be tracked through its life-time and after end of life-time of the instrument the source has to be disposed of in a safe way. The radiation hazard has to be handled during storage, transportation and installation. An X-ray based system will only be switched on after it has been installed and it does not represent any radiation hazard when switched off. Multiphase flow meters are installed worldwide and Roxar has experienced that in some parts of the world it is more difficult to install nucleonic gauges and there is a request for multiphase meters with no radioactive source.

Usually multiphase meters are equipped with a Cs-137 source for density measurement. For some years non-gamma multiphase meters have been available where the gamma-ray measurement is replaced with a patented algorithm that combines the information from the other flow measurements in the meter. The non-gamma meter does however have flow-range limitations and higher measurement uncertainty compared to the standard meter with gamma-ray source. The X-ray based flow meter is a new option without radioactive source that does not have these performance limitations.

It is an object of this invention to provide a multiphase meter without gamma sources such as Cs-137, and with the same or improved sensitivity. This is obtained in a meter as described in the accompanying claims.

The invention will be described below with reference to the accompanying drawings, illustrating the invention by way of examples.

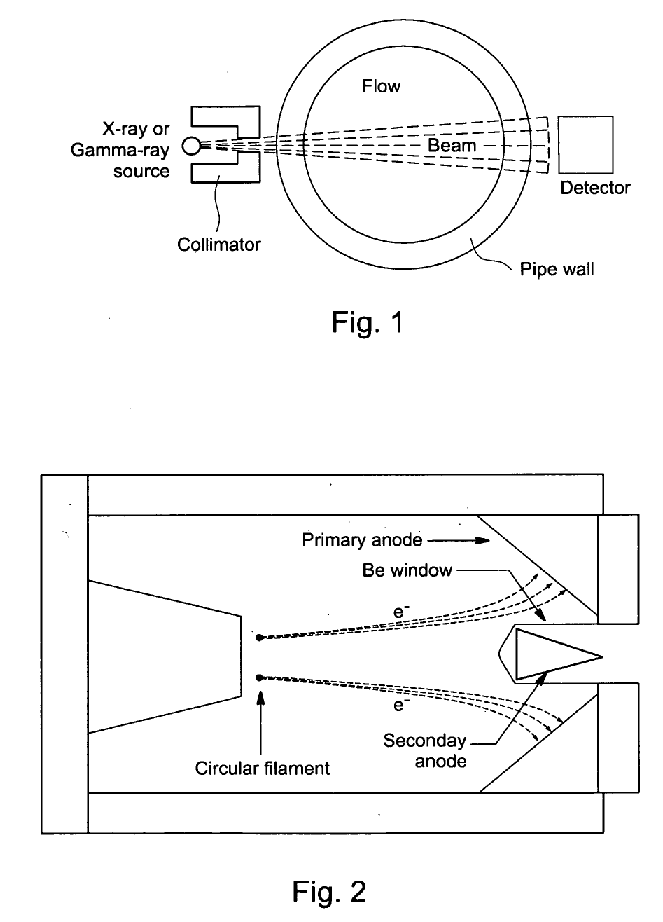

FIG. 1 illustrates the measuring setup according to the known art including a gamma source.

FIG. 2 illustrates a possible X-ray source used in the measuring unit according to the invention.

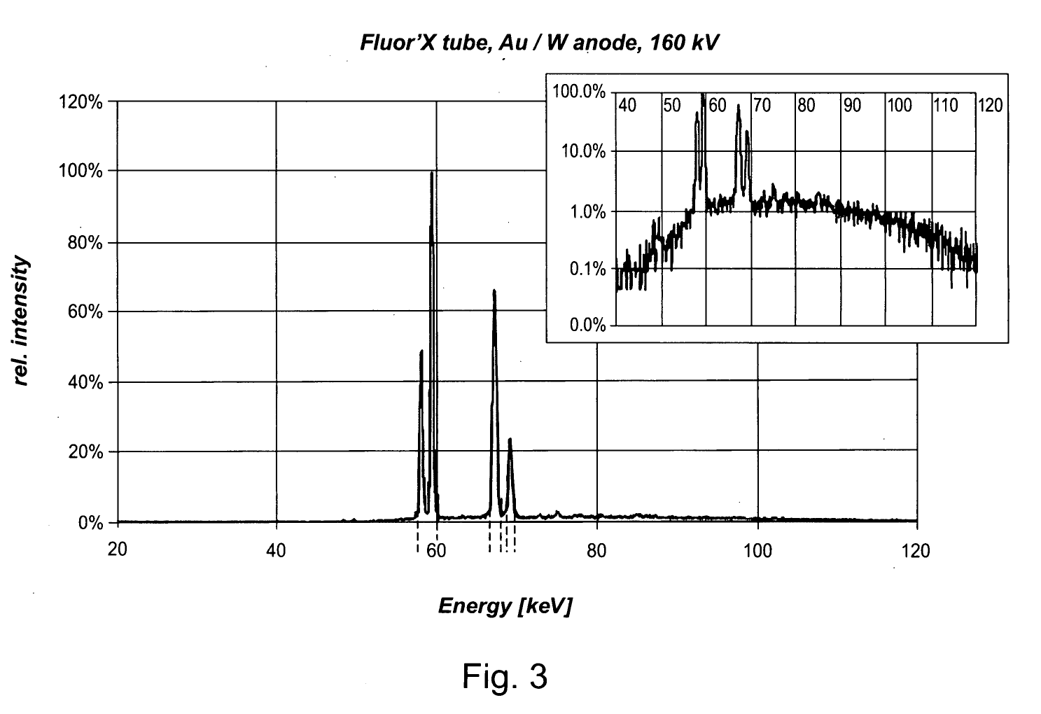

FIG. 3 shows a spectrum of a source of the type illustrated in FIG. 2.

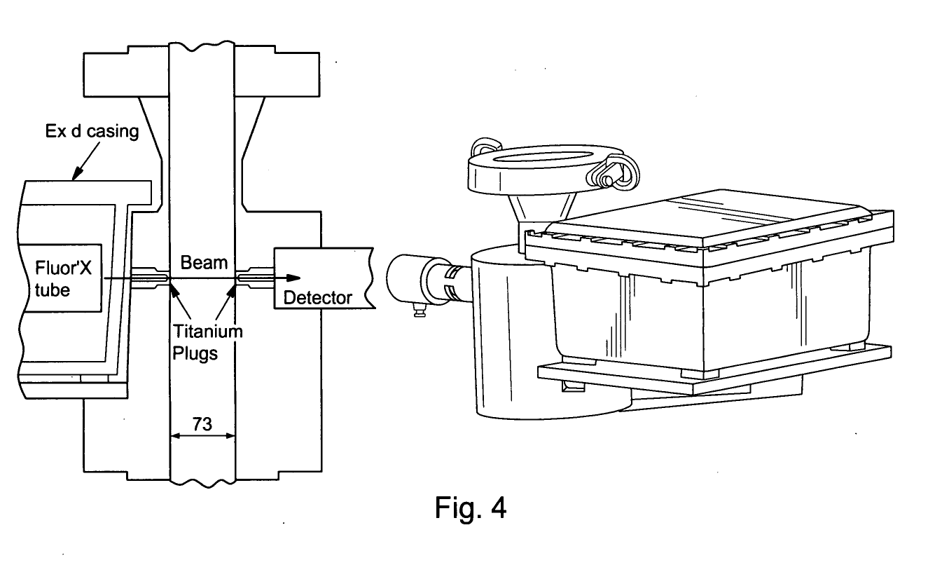

FIG. 4 illustrates a measuring unit according to the invention.

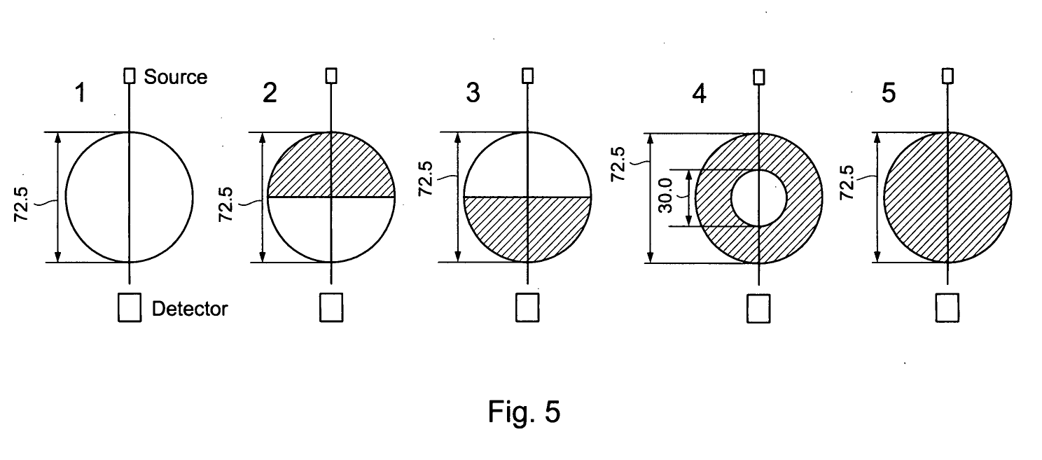

FIG. 5 illustrates 5 different test units for testing the unit according to the invention.

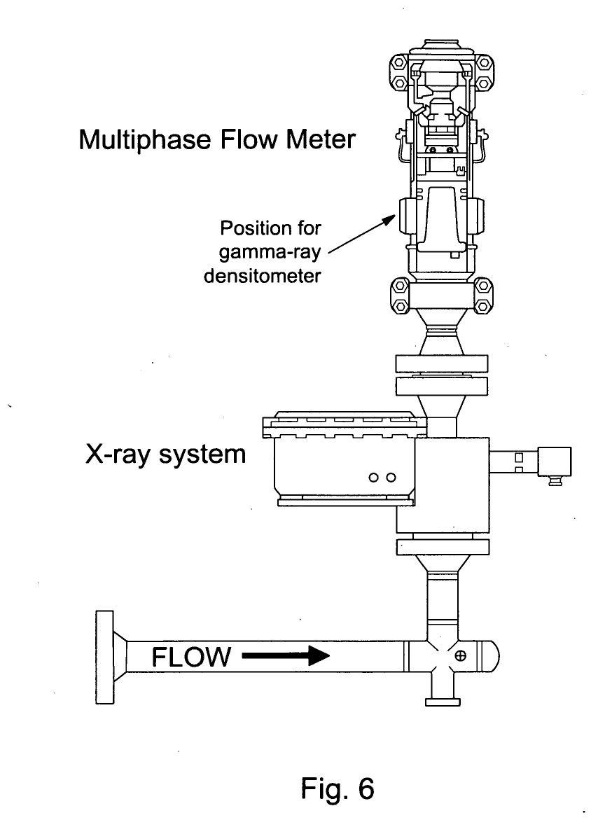

FIG. 6 illustrates a multiphase flow meter with a X-ray system according to the invention.

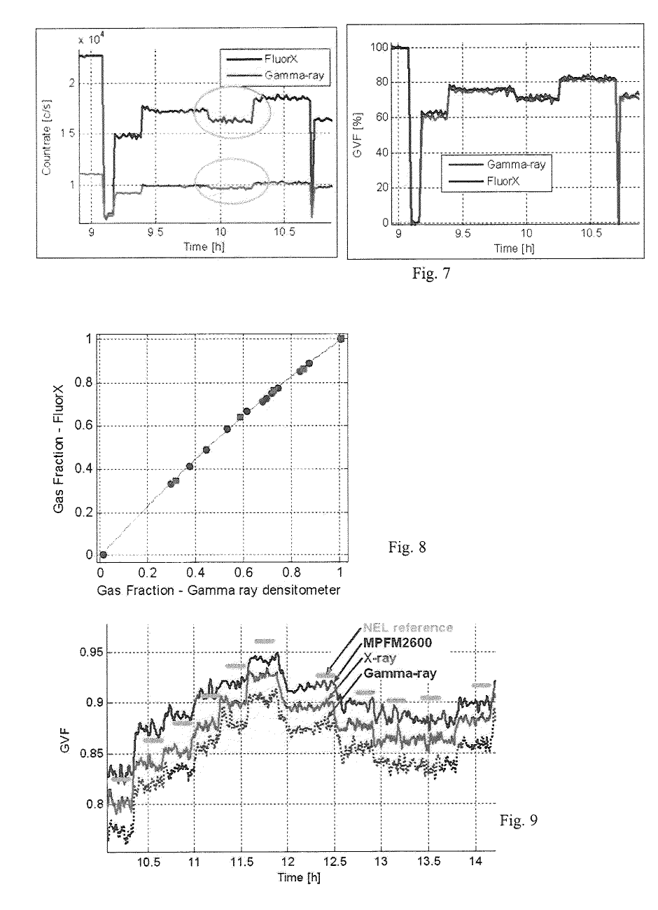

FIGS. 7-13 shows results of measurements performed when testing the unit according to the invention.

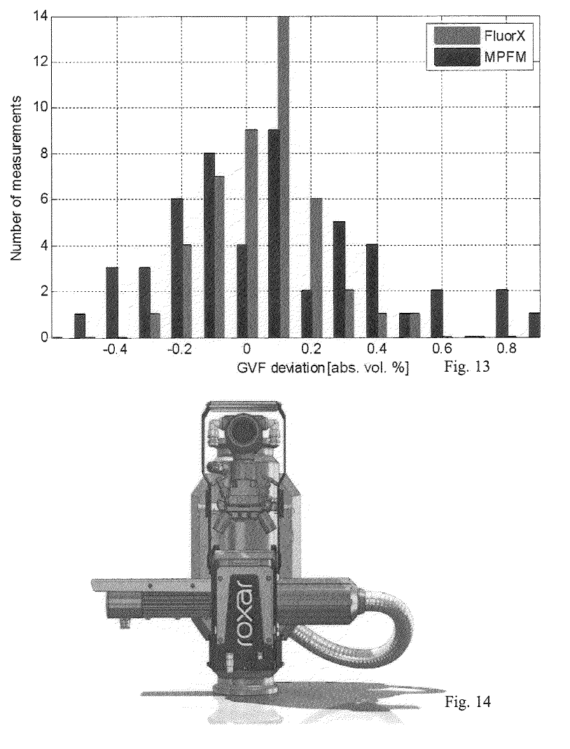

FIG. 14,15 shows two versions of the unit according to the invention.

FIG. 16 illustrates an alternative embodiment of the invention.

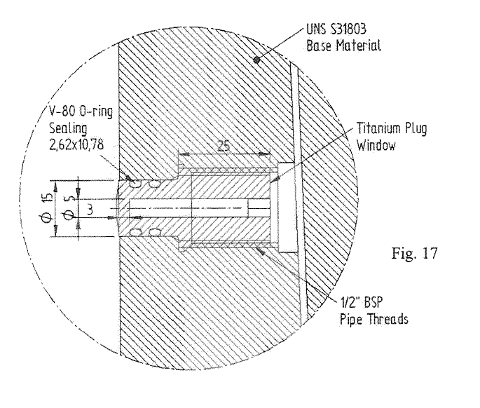

FIG. 17 illustrates the titanium plug according to the invention transmitting the X-rays into the flow and from the flow to the detector.

According to the present invention an X-ray based flow densitometer has been developed. The prototype meter has been successfully flow loop tested at Christian Michelsen Research (CMR) in Bergen and TUV NEL in Scotland. The flow testing includes both measurements on multiphase flow and on wet gas flow.

Flow composition measurement by gamma-ray and X-ray. Radioactive sources or X-ray tubes produce high energy photons that can be used in flow composition measurements. The basic measurement principle is the same independent on the origin of the photons. The attenuation of photons is measured along the narrow beam path in the flow. The beam is shaped by using a collimator that shields the radiation in other directions than that of the beam. The average attenuation coefficient of the flow components is thus the measured variable. This attenuation coefficient is dependent on the energy of the photons, the atomic composition of the flow and the density (or pressure) of the flow. The photon attenuation is not dependent on the origin of the photons. But it is possible to produce higher photon energy with a gamma-ray source than with an X-ray source. Due to the relatively low energy obtainable with an X-ray source it is required to use material with low density to transmit the beam through the pipe wall. According to the present invention the X-ray meter there are titanium plugs in the steel wall, where the beams are transmitted through.

A traditional X-ray tube produces a continuous energy spectrum, while a gamma-ray source has discrete energies. Interpreting the attenuation of a continuous energy spectrum is more complex compared to measuring the attenuation of a single energy beam. In the X-ray tube illustrated in FIG. 2 (also called the FluorX tube) and described in U.S. Pat. No. 4,903,287 and U.S. Pat. No. 5,157,704. These X-ray tubes mainly emit discrete characteristic energies providing an essentially monochromatic X-rays.

The X-ray tube used in the present invention produces photon energies close to 60 keV and the gamma-ray densitometer used in this work is based on Cs-137 with principal energy of 662 keV. Both of these energies are in the range where Compton scattering is the dominating interaction mechanism. The attenuation due to Compton scattering is about proportional to the density of the material and the measurements can be used for finding the density of the flow. There is, however, also some contribution from photoelectric effect, in particular for the X-ray beam. The photoelectric effect is strongly dependent on the atomic composition. A result of this is a higher salinity dependency of the low energy beam.

In the work presented here the gas volume fraction (GVF) has been calculated from the X-ray measurements and the gamma-ray measurements. The water cut (WC), fraction of water in the liquid, is found by capacitance measurements in the multiphase flow meter (MPFM) and this measurement has been used as input in the GVF calculations. The GVF measurements from the X-ray system and the gamma-ray system are compared. In these measurements flow regime effects and slip (different flow velocity for gas and liquid [2]) is not compensated for. Due to these effects it is expected that there will be deviation between the measured and the true GVF unless the flow is homogenous and with no slip. In the Roxar multiphase meter slip is measured and flow regime effects are also compensated for based on other flow measurements. Flow regime effects can also be compensated for by using multi-beam gamma or X-ray measurements [3].

The X-ray tube illustrated in FIG. 2 may be described as follows. The underlying principle of an x-ray tube is to accelerate electrons over a high voltage potential before hitting a heavy metal target, the anode. During the deceleration process the kinetic energy of the electrons is converted into x-rays and other forms of energy (mainly heat). A complex, highly polychromatic x-ray spectrum is generated in a conventional x-ray tube. The spectral definition consists of a continuous brehmsstrahlung contribution superimposed by the characteristic fluorescence lines in reference [1] of the anodic material being thus inadequate for multiphase flow measurements.

Based on a design in the abovementioned patents, the Fluor′ X tube is illustrated in FIG. 2, showing the architecture of the Fluor′X tube, including the indication of location and arrangement of the filament. The beam window, primary and secondary target, is capable to generate a near monochromatic spectrum which is much more suitable for gauging applications. In the Fluor′X tube a primary conical anode surrounds a beryllium cup holding a secondary conical target outside of the vacuum envelope (see FIG. 1). The inner side of the anode is coated with a high Z material, in this case gold, over a surface of few cm². Bombarded with electrons supplied by a circular filament, the primary anode becomes a source of polychromatic radiation which penetrates the beryllium window to excite the characteristic fluorescence lines of the secondary target material (W in our case). Since the secondary target is shielded by the beryllium cup against the scattered electrons, the brehmsstrahlung contribution in the out coming beam is significantly suppressed resulting in an output spectrum with mainly characteristic lines of the secondary target.

A previously reported version of the Fluor′ X tube [4] used electrons accelerated to 160 kV, water cooling system and a combination of Au/W as primary and secondary anodes, respectively. The spectral output of this tube is presented in FIG. 3, showing the energy spectrum for Fluor′X tube with 160 kV HV. The spectrum is scaled to 100% at the W k-alfa1 fluorescence peak. The insert shows on logarithmic scale the remainder of the background. This radiation has a strong characteristic line pattern which simplifies spectral interpretation and increase the confidence and quality of the collected data.

In line with this concept, a recently developed low power version of the Fluor′X tube was used to carry out this study. The tube length is about 20 cm.

This tube is compact and smaller in dimensions than its predecessor and is capable to work at maximum 100 kV supplied by a relatively small generator. Due to low power consumption the anode cooling is achieved only through heat conduction and free air convection. The Fluor′X design allows easy reconfiguration of the spectral output by using a wide range of secondary target materials. The user has the freedom to adjust the beam intensity and to choose even a composite material for the secondary target, thereby widening the application range of the Fluor′X tube.

The current version of the prototype X-ray densitometer was developed in 2007/2008 and first flow-tests were done in 2008. Main challenges for the design are combining the high voltage (100 kV), explosion safety and the transmission of the low-energy X-ray beam from the X-ray tube to the detector. In the prototype meter this was solved by placing the X-ray tube and the HV generator inside an aluminium extruded casing on the outside of the meter body. Low absorption plugs, preferably made from titanium are used to allow the beam to be transmitted through the walls of the meter body. The prototype is designed as a separate spool piece that can be installed alone or in series with a multiphase meter. Drawings of the meter are shown in FIG. 4. This first design of the gauge is fully operational and can be used in explosion hazardous atmosphere.

Concerning radiation safety, the meter has been designed to comply with the German “Vollshutz” standard according to Roentgenverordning 1987. Safety switches will shut down the beam if the box containing the X-ray tube and HV generator is out of position. The external dose-rate at 10 cm distance from the surface is below 1 microSv/h.

In this first version of the meter we have used standard components such as the Ex d casing for the generator and the product is thus not very compact and does not have a Roxar design

X-ray tubes are often used in laboratory instruments, where the environmental conditions such as temperature and vibration is quite different from the requirements for gauges used in oil and gas production. The X-ray tube and generator for the prototype meter has thus been specially designed for this application and the main design criteria are high stability of the X-ray beam, robustness and reliability. Computer simulations and extensive testing (according to the ISO 13628-6 standard) has been done on key components to obtain an optimal design. Both static tests on the complete system and flow loop testing have been performed. The main results from this testing are presented below.

Static tests were done by positioning polypropylene phantoms in the pipe spool. The plastic phantoms, which have about the same properties as oil concerning gamma/X-ray attenuation, are shaped as stratified and annular flow regimes.

Table 1 below shows the gas fraction measured along the centre beam. Measurements are compared with the true gas fraction along the beam. We can see that the difference is less that 0.7%. Taking into account that there is some uncertainty in the dimensions of the plastic phantoms this is about as accurate as it is possible to demonstrate.

In all gamma-ray or X-ray densitometers there is a contribution from scattered radiation in the measured count-rate. This is because radiation is not only absorbed but also scattered by the flow, pipe wall and other objects between the source and detector. The buildup is defined as the ratio between the measured detector intensity and the theoretical detector intensity with no scatter. So the number is always larger than 1. The contribution from scatter complicates the measurement analysis and it is thus preferable to have the buildup as low as possible. The scatter is dependent on the GVF and the flow regime and is difficult to predict. The buildup in the FluorX meter has been measured at different flow regimes, and it is found to be smaller than that of a Cs-137 based densitometer.

TABLE 1
Results from tests with polypropylene phantoms in FluorX meter.

| | | |
|---|---|---|
| Count- | av att | Gas fraction [%] |

| Plastic phantom | rate | coeff | theory | measured |
|---|---|---|---|---|
| 1. empty pipe | 10912 | 0.0000 | 100 | 100.0 |
| 2. stratified flow | 5788 | 0.1747 | 50 | 50.4 |
| 3. stratified flow | 5806 | 0.1738 | 50 | 50.6 |
| 4. annular flow | 5181 | 0.1749 | 41 | 41.7 |
| 5. pipe filled | 3042 | 0.1762 | 0 | 0.0 |

The plastic phantoms where made of polypropylene and their cross sections are illustrated in FIG. 5.

In all multiphase flow tests the prototype meter body has been installed in a vertical section of the pipeline after a T-blend. This is the standard way of installing the Roxar multiphase meter. The prototype has been installed in series with a multiphase meter with a gamma-ray densitometer, so the flow goes through the prototype before passing through the multiphase meter. FIG. 6 show the installation at the multiphase test loop.

First flow testing of the prototype X-ray densitometer has been performed. The prototype meter body was installed in series with an multiphase meter. In FIG. 7 time series of countrates and GVF measurements are plotted for the X-ray meter and the gamma-ray meter. The change of countrate is bigger for the X-ray meter and the measurement sensitivity is thus better for X-ray based system.

FIG. 7 shows the test results. Left: count rates (Fluor′X on top). A small change in GVF is easier to detect with FluorX as can be seen from the data indicated. Right: GVF

When comparing the GVF values from the X-ray meter with gamma-ray measurements (FIG. 8) it is evident that there is good correlation. But there are some systematic differences. This is as expected because the measurements are from two different cross-sections along the vertical pipe. The gamma-ray and X-ray measurements do not take flow velocity of the flow components into account. These test measurements are thus based on the assumption that the velocities of the different flow components are the same. This is often not the case. There will often be slip, which means that the gas is flowing with a higher velocity than the liquid. Due to different slip in the two cross-sections there will be deviation between the two gas fraction measurements. Other factors that could cause deviation is different flow regime and backflow of liquid in the vertical pipe section, causing a higher GVF at the highest flow cross-section. This is probably the reason why the measured GVF was higher at the upper measurement cross-section (the gamma-ray densitometer) for the CMR flow data.

FIG. 8 illustrates the gas fraction measured by the Fluor′X system compared to the gamma-ray densitometer measurements.

Flow loop tests on both multiphase and wet gas flow have been carried out. The X-ray meter was installed in series with a traditional multiphase meter with gamma-ray densitometer (6). A time series plot of GVF measurements are shown in FIG. 13. The gas fraction measured in the gamma-ray densitometer is lower because of higher gas velocity (slip) in the upper measurement cross-section. The traditional multiphase meter data shown are also based on the gamma-ray densitometer, but these data are also combined with other measurements in the multiphase meter and the GVF is thus corrected for slip and other flow-regime effects.

in FIG. 9 the NEL reference data for the measurement points are plotted in green. GVF calculated from X-ray measurements, from the gamma-ray data and GVF from the traditional multiphase meter (MPFM2600) is shown. Data are average values over 25 s.

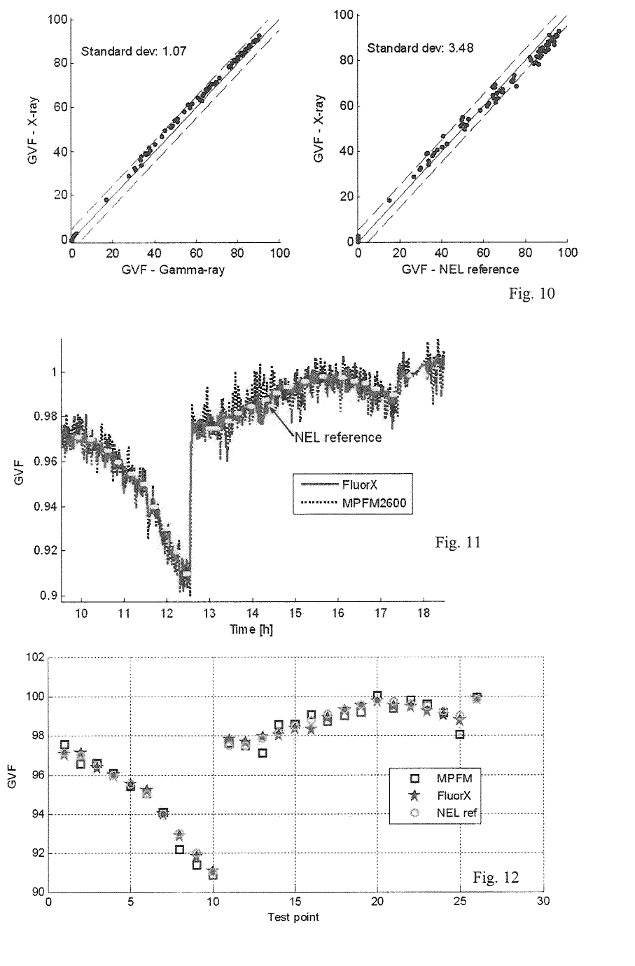

FIG. 10 show the X-ray measurements compared with gamma-ray measurements and compared with the NEL reference data. Also here we see the deviation between gas fraction in the measurement cross-section of the X-ray meter and the gamma-ray meter. Further, we see that the GVF from the X-ray measurement is underestimated at high GVF when compared with reference data. This is due to higher slip at high GVF and can be compensated for in a multiphase flow meter.

FIG. 10. GVF measured by Fluor′X plotted against GVF measured by gamma-ray data (left) and against NEL reference data (right). Right: Dashed lines show +/−5%

The X-ray meter was also tested in the wet gas loop. The test-section was identical to the one used in the multiphase loop. The X-ray meter was placed under a MPFM2600 meter in a vertical section of the pipe. The GVF was above 90% and the flow pressure was between 30 and 55 bar. The flow components were nitrogen gas and kerosene liquid.

Time series plots of GVF measurements are shown in Figure. The X-ray data show smaller fluctuations from the NEL reference data than the gamma-ray data. When compared with multiphase flow the wet gas flow is more or less homogenous and liquid is flowing at the same velocity as the gas. There is thus less influence from slip and flow regime effects on the measurements.

FIG. 11. Measured GVF and NEL reference values, Measurements were recorded in NEL gas loop. Integration time: 25 s.

The measured GVF values for a number of test points are shown in FIG. 12. The gamma-ray (662 keV) measurements show larger deviation. This can also be seen in FIG. 13 where the measurement error for all the wet-gas test points are plotted in a histogram. The standard deviation of the GVF X-ray measurements are about half that of the gamma-ray measurements: 0.16% vs. 0.37% absolute. The low energy used in the X-ray meter is more suitable for the low density wet gas flow. Theoretical calculations show that at wet gas flow with 50 bar pressure the relative uncertainty of the measured attenuation coefficient is about double for 662 keV compared to at 60 keV. So the measurement results are in compliance with the theory.

FIG. 13 illustrates test points recorded in NEL gas flowloop where measured and reference GVF values are plotted, and FIG. 14 illustrates histogram of measurement deviation for Fluor′X measurements and gamma-ray measurements.

Regarding the stability of the beam intensity, the gamma-ray densitometer the intensity of the beam is proportional to the activity of the radioactive source. The beam intensity is thus very predictable. For the X-ray meter the beam intensity is dependent on a number of factors, such as the high voltage, the emission current and mechanical dimensions inside the X-ray tube. It is important that the photon intensity does not fluctuate due to temperature variations, vibrations or other environmental factors. The Fluor′X tube has been specially designed to minimize such fluctuations. The Fluor′X tubes that have been tested have shown an acceptable stability. At the NEL test the beam intensity for empty pipe was recorded every day, and the standard deviation for these measurements for the whole test period was 0.1%. Beam stability is further improved in a later version of the Fluor′X tube.

In a final design of the X-ray system is preferably integrated as a part of the multiphase flow meter. It is today possible to get topside multiphase meter in a non gamma version and with gamma-ray densitometer. The X-ray system will then be a third option for the meter, with this option it will be possible to have a flow meter without the limitations on measurement accuracy and flow ranges that the non gamma meter has.

A concept design for X-ray system installed on multiphase flow meter is shown in FIG. 14. By placing the HV generator in a separate Extruded casing a more practical design is achieved.

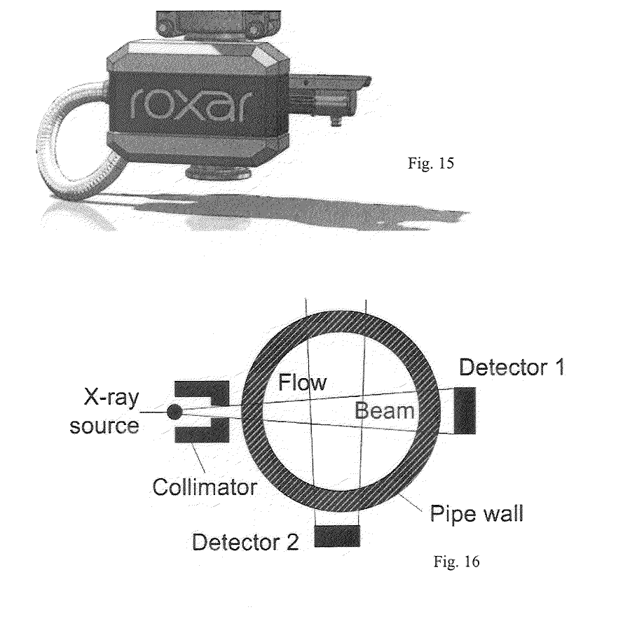

It could also be useful to have the X-ray system as a separate spool piece, a sketch of this is shown in FIG. 15. It could then be installed as a stand alone meter or in series with a non-gamma meter.

The use of an X-ray system opens for new possibilities for flow composition measurement. Both the intensity of the beam and the photon energy can be adjusted to fit the application. In the Fluor′X technology there is a possibility to choose the energy of the photons by choosing the material for the secondary anode. It is possible to use lower photon energy than what has been used in our prototype tests, and this enables higher measurement accuracy in low density flow, such as wet gas. There is also a possibility for using multiple energy beams, which makes it possible to find more flow information such as water cut and water salinity. Water salinity can also be measured by combining the measurement of scattered and transmitted radiation (Dual modality densitometry) [2], as illustrated in FIG. 16 where an extra detector is positioned at a 90 degree angle from the beam measuring the radiation scattered in the flow.

The beam intensity can be changed during the measurement. When increasing the beam intensity the time-resolution of the measurements is improved and more detailed flow information can be obtained

A prototype X-ray flow composition meter based on the patented Fluor′X tube been built and flow tested. The tests show that it is possible to replace the traditional gamma-ray densitometer on the Roxar multiphase flow meter with the X-ray system. The X-ray system shows higher measurement sensitivity in all flow tests, and in particular for low density flow. The radiation safety during operation of the meter is fully acceptable and during installation, storage and transportation the radiation hazard is removed. The X-ray based flow composition gauge will be a valuable alternative to the gamma-ray densitometer in future Roxar multiphase meters.

FIG. 17 illustrates the titanium plug transmitting the radiation between the source and the flow, and possibly also between the detectors and the flow. While the meter body usually is constructed in corrosion resistant steel the plug is preferably made from grade 2 titanium, which, due to the relatively low atom number lets the radiation be transmitted through it. It is also sealed against the housing with O-rings and screwed into corresponding threads in the housing. The titanium plug has an axial cavity reaching through a part of the plug length so as to reduce the attenuation of the radiation further.

To summarize the invention thus relates to a multiphase flow measuring unit for performing X-ray density measurements on a fluid flow, the unit comprising an X-ray source generating an X-ray beam within a chosen spectral range and a first detector aimed at the beam for detecting radiation scattered by or transmitted through the flow, the spectral range comprising a narrow, essentially monochromatic range. The X-ray source is preferably adapted for fluorescence measurements and thus preferably provides radiation within the range of 20 keV to 100 keV, and especially approximately 60 keV.

When mounted into a pipe a radiation window is provided in the wall of the pipe containing the flow, between the source and the flow. The radiation window is preferably made from a titanium plug. A similar plug may also be used between the flow and a detector.

For precise measurements the measuring unit may also comprise a means for measuring permittivity and/or differential pressure in the flow so as to characterize the fluid flow.

In addition to the detector positioned on the opposite side of the pipe measuring the transmitted radiation additional detectors may be positioned outside the beam path so as to measure scattered radiation. For example a second detector may be positioned at an angle from the beam measuring radiation scattered in that direction and/or a third detector may be positioned close to the source, thus measuring direct radiation from the source. In this way the third detector acts as a source beam monitoring detector so that any intensity drift of the source beam could be compensated for.

The application requires high stability of both source beam intensity and detector intensity response. Means of obtaining both stable source and detector are thus required to be used. In this system scintillation detectors with photomultiplier tubes are used. High stability is obtained by tracking the peak in the energy spectrum. The high voltage for the PMT is continuously adjusted so that the full energy peak is always on the same position in the energy spectrum. This means that the detector signal amplification will be close to constant and not significantly affected by ageing effects or temperature.

### REFERENCES

1. G. A. Johansen and P. Jackson, Radioisotope gauges for industrial process measurements John Wiley & Sons, Ltd. (2004) 33 pp
2. S. Corneliussen et al. Handbook of multiphase flow metering, rev 2 2005 (www.nfogm.no)
3. G. A. Johansen and S A Tjugum, Fluid composition analysis by multiple gamma-ray beam and modality measurements North Sea Flow Measurement Workshop 2007
4. J. Marfeld, G. E. van Dorssen, M. Niestadt, Fluor′X-A near monochromatic X-ray source, Proc. SPIE Vol. 4502, p. 117-125, Advances in Laboratory-based X-Ray Sources and Optics II, Ali M. Khounsary; Carolyn A. MacDonald; Eds.

1. Multiphase flow measuring unit for performing X-ray density measurements on a fluid flow, the unit comprising an X-ray source generating an X-ray beam with discrete energies by utilizing secondary fluorescence and a first detector aimed at the beam for detecting radiation transmitted through the flow.

2. Measuring unit according to claim 1, wherein the X-ray source provides radiation within the range of 20 keV to 100 keV, and preferably around 60 keV.

3. Measuring unit according to claim 1, wherein a radiation window is provided in the wall of the pipe containing the flow, between the source and the flow, the radiation window being made from a low density/low absorption material.

4. Measuring unit according to claim 3, wherein the window is made from a titanium plug provided into the wall.

5. Measuring unit according to claim 3, also comprising a titanium plug between the flow and a detector.

6. Measuring unit according to claim 1 also including means for measuring permittivity and/or differential pressure in the flow so as to characterize the fluid flow.

7. Measuring unit according to claim 1, including a second detector positioned at one side of the beam and aimed toward the beam, thus measuring radiation scattered toward said second detector.

8. Measuring unit according to claim 1, including a beam monitoring detector for measuring beam intensity close to the X-ray tube, thus measuring the beam intensity at the source.

9. Measuring unit according to claim 1, also comprising means of stabilizing beam intensity from X-ray tube.

10. Measuring unit according to claim 1 including a automatic detector stabilization means adapted to monitoring the energy spectrum received at the detector.
